(19) United States
(12) Patent Application Publication
(10) Pub. No.: US 2008/0261585 A1
(43) Pub. Date: Oct. 23, 2008

(54) Radiocommunication Equipment Monitoring and Control System

(76) Inventor: Elias Augusto de Souza, Itapecerica da Serra - SP (BR)

Correspondence Address: STITES & HARBISON PLLC, 1199 NORTH FAIRFAX STREET, SUITE 900, ALEXANDRIA, VA, 22314, US

(21) Appl. No.: 11/995,383

(22) PCT Filed: Jun. 28, 2006
(86) PCT No.: PCT/BR06/00129

§ 371 Date: Jun. 23, 2008

(30) Foreign Application Priority Data
Jul. 11, 2005 (BR) PI0502701-2

(51) Int. Cl. H04Q 7/34

(52) U.S. Cl. 455/423

(57) ABSTRACT

Monitoring and control system for radiocommunication equipment, comprised of a recording and monitoring set (CM), a computer equipped with a specific and dedicated software and a decoder PCI board (2, 2a), and such computer is provided of peripherals defined by a radio (Rt), a power supply and antenna; and such system can enable as many radiocommunication equipment (R1, R2, R3, R4, Rn−1, Rn) as necessary for network monitoring and control, and each radiocommunication equipment (R1, R2, R3, R4, Rn−1, Rn) is enabled by an identifier (ID), so that every time a message is sent, a decoder PCI board matches the (ID) using DTMF and/or MDC1200 and/or 5TONS tones, and stores audio, date, time minute and second of transmission start and end, name, section and user ID for further audio play by period or by user. The system also allows to define preset audio alert signals and enabled through radiocommunication equipment and/or CM through DTMF and/or MDC1200 and/or 5TONS tones, as well as for equipment and assets registration by model, quantity and transmit and receive frequencies.

This report describes a radiocommunication monitoring and control system and, more particularly, an on-going monitoring and control, audio recording and play system from a portable or mobile radiocommunication equipment operating within VHF and/or UHF and/or HF and/or SSB ranges.

As far as technician's knowledge is concerned, radiocommunication equipments or sets of radiocommunication equipments are used today to fully promote the communication between a radiocommunication network for indoor and outdoor environments, where people's affluence is significative, such as shopping center, supermarkets, event squares, industries, airports, clubs, edge cities among others.

Generally, this communication service is given by a group of users provided with radiocommunication equipment allowing to communicate between network users within a preset frequency range.

Those commonly known systems allow to keep or record conversations kept between the users in magnetic tapes, electronic format for computer or equivalent, through a network-deployed recording equipment.

Although providing a satisfactory result, those conventional systems have some setbacks to be mentioned, which is the fact of coding and decoding only DTMF protocol tones and could not identify conversation during play, who is talking to whom, unless each official report system user is identified. In that case, conversation becomes very tiresome and slow, since for people's identification conversation is interwoven with the nominal identification or codified to each user's intervention.

In addition to this, another relevant problem is that recorded audio play time control, because the recording system stores many communications in the same file or electronic “packet” of minutes, therefore, its determination is very complicated for the people in conversation, since it won't allow to figure out the name and ID of the calling person, as well as the start and end time between each recording during conversation playback.

So, current systems shall not allow to identify people in conversation to be played, as well as determine the exact conversation time, on-going and uninterrupted monitoring and radio system control monitoring by message event, including automatic coding and decoding of MDC1200 and/or 5TONS protocol tones. This invention is used to provide a monitoring and control system for radiocommunication equipment, to enable continuous recording and storage of the conversations held between users by means of a digitized transmission event of each message using a processing unit deployed in the radiocommunication network which decodes DTMF and/or MDC1200 and/or 5TONS protocol.

Another use for this invention is to provide a monitoring and control system for radicommunication equipment that ensures user's identification during recording and playback of a conversation, in other words, one knows permanently who is speaking with whom, without the need of system user identification every time radio system breaks in.

Another use for this invention is to provide a monitoring and control system for radicommunication equipment to ensure a lasting break in date, time, minute and second control through the radiocommunication equipment for easier and exact determination of the people in conversation and conversation time during recording and playback.

Therefore, using this monitoring and control system for radiocommunication equipments you can simultaneously identify the people who is talking during the recording or playback of the conversation, determine the exact time of the conversation, continuous and uninterrupted radio system monitoring and control recording, irrespective of the number of operating radiocommunication equipment, which is accomplished through automatic decodes of protocols DTMF and MDC1200 and 5TONS protocols.

These and other purposes and benefits of this invention are achieved with a monitoring and control system for radiocommunication equipment including a recording set comprised of a computer equipped with a specific and dedicated software and a decoder PCI board, and such computer is provided of peripherals defined by a radiocommunication equipment, a power supply and antenna; such system can enable as many radiocommunication equipment as necessary for the monitoring of a given event, and each radiocommunication equipment is enabled by an identifier (ID), so that every time it send a message, the system tracks the operator by automatically coding and decoding it through DTMF and/or MDC1200 and/or 5TONS protocols, and stores transmission start and end audio, date, time minute and second, name, sector and user ID.

The present invention is described with reference to the attached graphics:

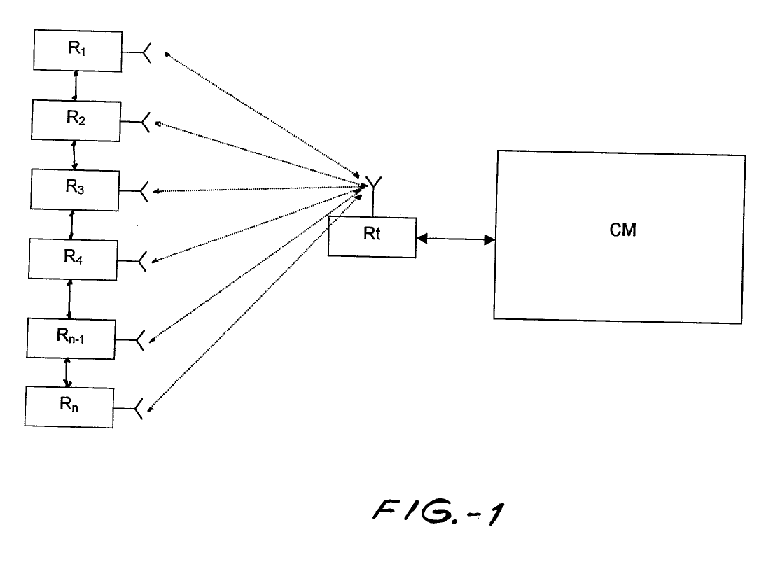

FIG. 1 is a schematics of a radiocommunication network assembled by the monitoring and control system for radiocommunication equipment; and

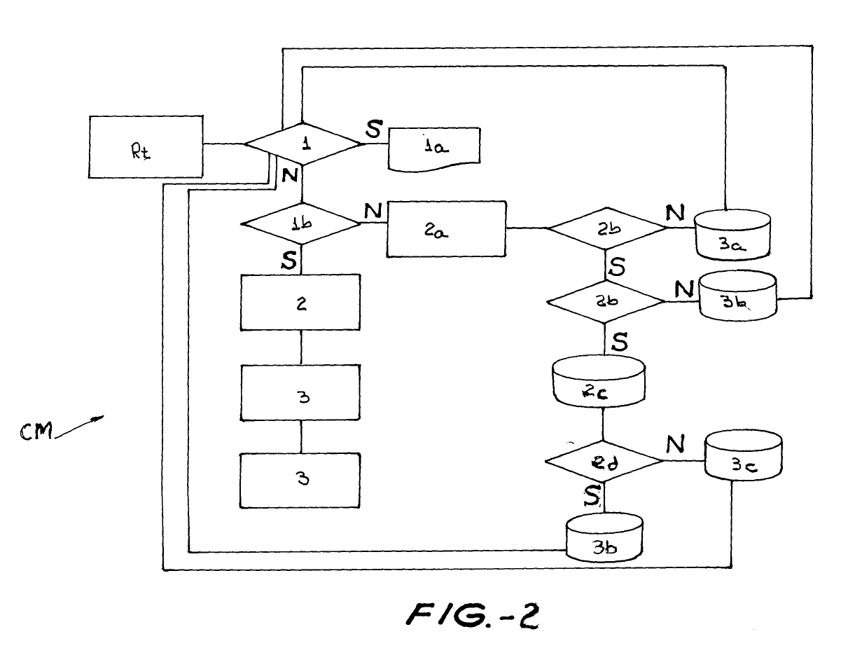

FIG. 2 depicts a block diagram of a recording set for including a computer with the specific and dedicated software and decoder PCI board, which comprises the monitoring and control system for radiocommunication equipment as show in FIG. 1.

According to these illustrations, the monitoring and control system for radiocommunication equipment comprises miscellaneous R₁, R₂, R₃, R₄, Rₙ₋₁, Rₙ radiocommunication equipments part of a monitoring and control network, each one of the R₁, R₂, R₃, R₄, Rₙ₋₁, Rₙ radios of that network is authorized by a CM monitoring center using an ID, so that every time such R₁, R₂, R₃, R₄, Rₙ₋₁, Rₙ radio sends a message through the network, CM center tracks the user through a Rₜ radio equipment permanently in 1, 1a, 1b waiting status, through a logical controlling PCI board 2 and automatic coding and decoding of DTMF and/or MDC1200 and/or 5TONS protocols to perform recording 3 of audio, date, time, minute and second at the start and end of the transmission, name, section and user ID. If the code does not match those stored in the system, the decoder PCI board 2a checks for DTMF and/or MDC1200 and/or 5TONS 2b tones; otherwise its stored the communication to database 3a without an ID, recording audio+data+time, minute and second only and placing the system in waiting 1 status. However, if DTMF and/or MDC1200 and/or 5TONS 2b tone is verified, in case ID does not mach the ID previously entered in the database, it is recorded to database 3b with a failed ID, by recording audio+data+time, minute and second only and placing the system in waiting 1 status. However, in case the ID previously entered in the database is decrypted, a 2c search is performed in the database. If user 2d is not matched, database 3b stores that user equipment is matched, and a failed ID message is reported, then records audio+data+time, minute and second only and placing the system in waiting 1 status. If previously entered ID is coded, database performs 2c search, but if user 2d register is not identified, it is recorded in the 3c database as unregistered user, then records audio+data+time, minute and second only and placing the system in waiting 1 status

CM monitoring center comprised a recording set including a computer provided with specific and dedicated software and logical controlling PCI board, and such computer is equipped with peripherals defined by Rₜ radiocommunication equipment, power supply and antenna. The referred system operates in the VHF and/or, UHF and/or, HF and/or SSB frequency ranges.

The system also allows to define preset audio alert signals and enabled through radiocommunication equipment or CM through DTMF and/or MDC1200 and/or 5TONS tones.

With a system configured as above you can enable as many R₁₇ R₂, R₃, R₄, Rₙ₋₁ Rₙ radiocommunication equipment as necessary for the monitoring and control of a certain event, ensure and on-going recovery and generation of reports about conversations occurred with full identification of the conversation, including date, time, minute and second of transmission start and end, name, section and user ID.

The monitoring and control system for radiocommunication equipment operation is as follows: To record a communication network, you must register R₁, R₂, R₃, R₄, Rₙ₋₁, Rₙ radiocommunication equipment belonging to the network first, its respective “ID”, section and username (i.e.: John Doe, Security Department). After this system identification or registration, next time the user communicates with his/her R₁, R₂, R₃, R₄, Rₙ₋₁, Rₙ e Rₜ radio equipment, he/she will be identified by his/her “ID” through DTMF and/or MDC1200 and/or 5TONS protocols, allowing the computer to store the data of the operator to a database 4, then it starts to record audio, date, time, minute and second of transmission start and end, name, section and user ID, known as communication record.

All communication among all users enabled by network is stored in the system database for further audio play or real time conversation tracking.

To play the audio a system filter is selected for the users, date and time, minute and second (start and end). The system will play the audio by displaying computer name, date, time, minute, and second of each user on screen at the time speech is played.

Therefore, the monitoring and control system for radiocommunication equipments can be used to record, track and play audio signals, user, ID, date and time, minute and second start and end of a communication, locally or remotely, through Internet, LAN, dialed line, broadband, GPRS or mobile, by decoding or not one or more radiocommunication equipments, portable or mobile in the VHF or, UHF or, HF or SSB ranges, using DTMF and/or MDC1200 and/or 5TONS protocols. Audio recording of the radiocommunication equipment shall occur each time the recording system identifies any RF transmission (radio frequency) within the preset frequency in radio which is part of the specific computer system. If such RF transmission is followed by a DTMF and/or MDC 1200 and/or 5TONS tone and these codes are previously entered in the specific computer system, it will record the audio, equipment transmitter ID, date, time, minute and second at the beginning and end of the transmission, name and user's section.

Although described and illustrated as a primary constructive concept, it is worth to point out that project changes are possible and achievable is without detaching from the invention scope.

1. Monitoring and control system for radiocommunication equipment comprising a recording and tracking set, a computer equipped with a specific and dedicated software and a decoder PCI board, and such computer is provided of peripherals defined by a radio, a power supply and antenna; and such system can enable as many radiocommunication equipment as necessary for the monitoring of a given event, and each radiocommunication equipment is enabled by an identifier (ID), so that every time it sends a message, the system tracks the operator by automatically coding and decoding it through DTMF and/or MDC1200 and/or 5TONS protocols, and stores transmission start and end audio, date, time minute and second, name, section and user ID.

2. Monitoring and control system for radiocommunication equipment according to claim 1, featuring each radiocommunication equipment sending a message from network to center through a radiocommunication equipment permanently set to waiting status, which previously identifies the user through a decoder PCI board, then records audio, date, time, minute and second of transmission start and end, name, section and user ID.

3. Monitoring and control system for radiocommunication equipment according claim 2, which features a signal captured by the radiocommunication equipment, does not match those stored in the system, the decoder PCI board W checks for DTMF and/or MDC1200 and/or 5TONS tone and, if there is no tone, it stores the speech with ID to a databases, then records audio+date+time, minute and second only, placing the system in waiting status.

4. Monitoring and control stem for radiocommunication equipment according to claim 2, which features that, if the ID previously entered in the database is decrypted, a search is performed in the database if user equipment code is matched, but the user is not, database stores a failed ID message and the fail is reported, then records audio+data+time, minute and second only and placing the system in waiting status.

5. Monitoring and control system for radiocommunication equipment according to, which features that, if the ID previously entered in the database is decrypted, a search (2c) is performed in the database; if user equipment code is matched and user is stored in the database as unregistered user, then records audio+data+time, minute and second only and placing the system in waiting status.

6. Monitoring and control system for radiocommunication equipment according to, claim 2, which features a Monitoring Center operating with radio signal within VHF or UHF or HF or SSB frequency ranges.

7. Monitoring and control system for radiocommunication equipment according to claim 2, which features audio play selected by means of system filters: user(s), date and time, minute and second (start and end); since the system will play the audio by displaying computer name, date, time, minute second of each user on screen at the time speech is played.

8. Monitoring and control system for radiocommunication equipment according to claim 2 features locally or remotely performed recording, monitoring and audio play over the Internet, LAN, dialed line, broadband, GPRS or mobile.

9. Monitoring and control system for radiocommunication equipment according to claim 2, which features preset audio signals enabling and definitions, which are enabled by radiocommunication equipment or CM through DTMF and/or MDC1200 and/or 5 TONS tones.
